(19) United States
(12) Patent Application Publication
(10) Pub. No.: US 2014/0318856 A1
(43) Pub. Date: Oct. 30, 2014

(54) Seal Adapter Device and Kit Assembly

(71) Applicant: Timothy Carman, New Orleans, LA (US)

(72) Inventor: Timothy Carman, New Orleans, LA (US)

(21) Appl. No.: 13/870,978

(22) Filed: Apr. 25, 2013

(51) Int. Cl. H02G 15/013

(52) U.S. Cl. CPC H02G 15/013
USPC 174/655; 174/668

(57) ABSTRACT

A seal adapter for guiding an electric or data cable through an entry port into an electric distribution box has a seal adapter body capable of being threaded into an existing entry port of the distribution box. The seal adapter body has a first hollow portion carrying exterior threads and an enlarged-size cap integrally continuously formed with the first portion, the second portion extending transversely to a central axis of the first portion. The cap is capable of being drilled to form a pre-determined size opening for threading the cable therethrough. A kit containing the seal adapter may also include a pair of sealing rings and a conduit connector which engages with the cap of the seal adapter and extends outwardly from the distribution box. The conduit connector and the seal adapter form a seal around a guiding end of the cable forming a weather-tight entry for the cable.

### BACKGROUND OF THE INVENTION

The present invention generally relates to electric adapters used with communications enclosures, and, more particularly to an electric seal adapter assembly for use when guiding a power or data cables through an entry port of a distribution box.

Power and communication distribution boxes or enclosures are used as components of electric or telecommunications supply system, which divides an electrical or communications power feed into subsidiary circuits. The distribution box also provides a protective enclosure for fuses and circuit breakers mounted on a distribution panel inside the box. Distribution boxes are designed for mounting on walls or other structures at the premises. Conventional cable distribution boxes have a cable entry port at a side of the box for receiving a cable originating from a network provider, and one or more ports at the same or the other side of the box through which a number of wires associated with individual subscribers at the premises are routed to connect with wires in the provider cable.

The distribution boxes can be made of metal or plastic, and a moisture-proof seal is provided to seal the cable entry port. However, standard entry ports may not suitable for all types of cable bundles, and the installer has to resort to drilling out the port to enlarge the opening and allow a different diameter cable to be guided through the entry port. If the distribution box is made of metal, a problem of metal shavings present in the immediate vicinity of the cable is created. Furthermore, convention seal are likely to contain metal parts that could create a magnetic field adversely affecting telecommunications.

The present invention contemplates elimination of drawbacks associated with conventional seals and provision of an electric seal adapter and a kit assembly that can be used for sealing the entry port for a cable guided into a distribution box. The present invention also provides for a kit that incorporates the seal adapter and elements to assist in positioning of the seat adapter on a wall of a distribution box.

### SUMMARY OF THE INVENTION

It is, therefore, an object of the present invention to provide a seal adapter that can be used to seal a cable entry port of an electric distribution or data cable distribution box.

It is another object of the invention to provide a seal adapter kit that can be used for sealing a cable entry port of an electric distribution, data cable distribution box, or fiber optic cable distribution box.

These and other objects of the invention are achieved through a provision of a seal adapter device for guiding a cable through an entry port into a distribution box. The seal adapter comprises a seal adapter body capable of being threaded into an existing entry port of the distribution box. The seal adapter body has a first hollow cylindrical portion carrying exterior threads and an enlarged-size cap integrally continuously formed with the first portion. The cap has a polygonal configuration and extends transversely to a central axis of the first portion.

The kit assembly according to this invention comprises the seal adapter device, a conduit connector member engageable with the seal adapter device, a first sealing ring engageable with the conduit connector member and a second sealing ring engageable with the seal adapter device. The second sealing ring is engageable with exterior threads of the first portion, while the first sealing ring is engageable with a threaded proximate end of the conduit connector member. The cap of the seal adapter device is capable of being drilled when forming an opening in the cap through which the cable extends. An indentation is formed in a center part of the cap and serves as a guide for drilling of the cap.

The second sealing ring carries a second sealing O-ring positionable between an interior wall of the distribution box and the second sealing ring. A first sealing O-ring is positionable between the conduit connector member and an exterior surface of the distribution box wall. When positioned on the distribution box, the assembly of this invention forms a weather-tight seal around the entry port of the cable.

### BRIEF DESCRIPTION OF THE DRAWINGS

Reference will now be made to the drawings, wherein like parts are designated by like numerals, and wherein

FIG. 1 is a perspective view of the adapter seal assembly of the present invention mounted on a wall of a distribution box.

FIG. 2 illustrates a method of preparing the seal adapter, with the elements of the kit assembly shown in an exploded view.

FIG. 3 is an exploded view of the seal adapter kit assembly according to the present invention.

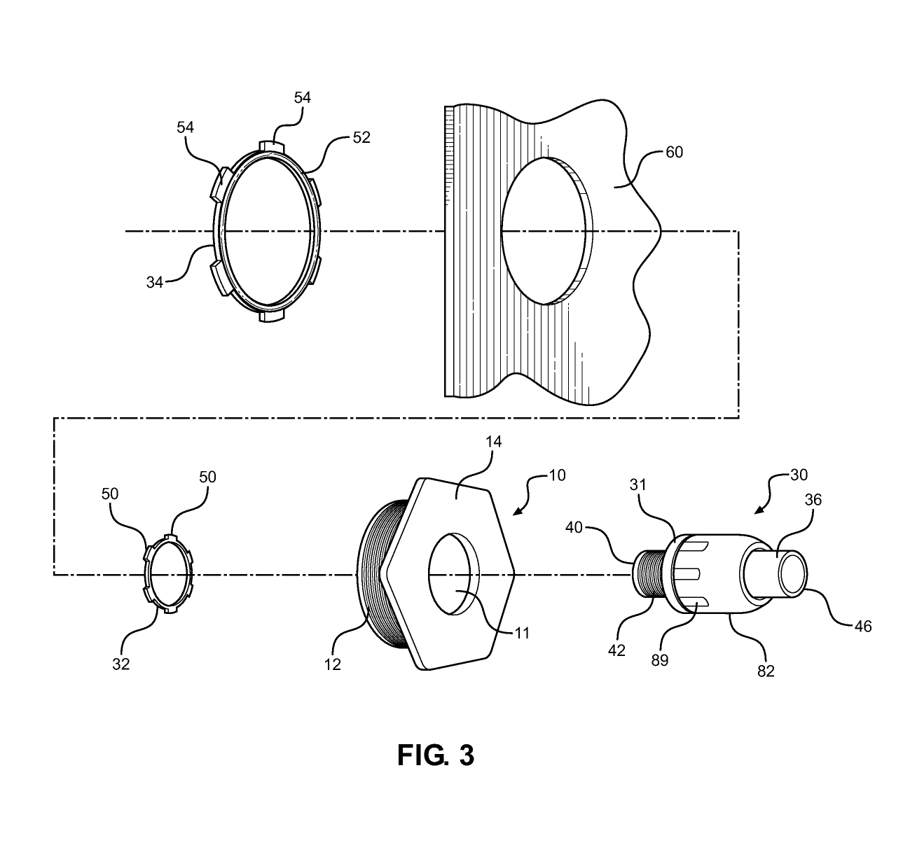

FIG. 4 is a cross-sectional view of the seal adapter assembly of this invention mounted on the distribution box.

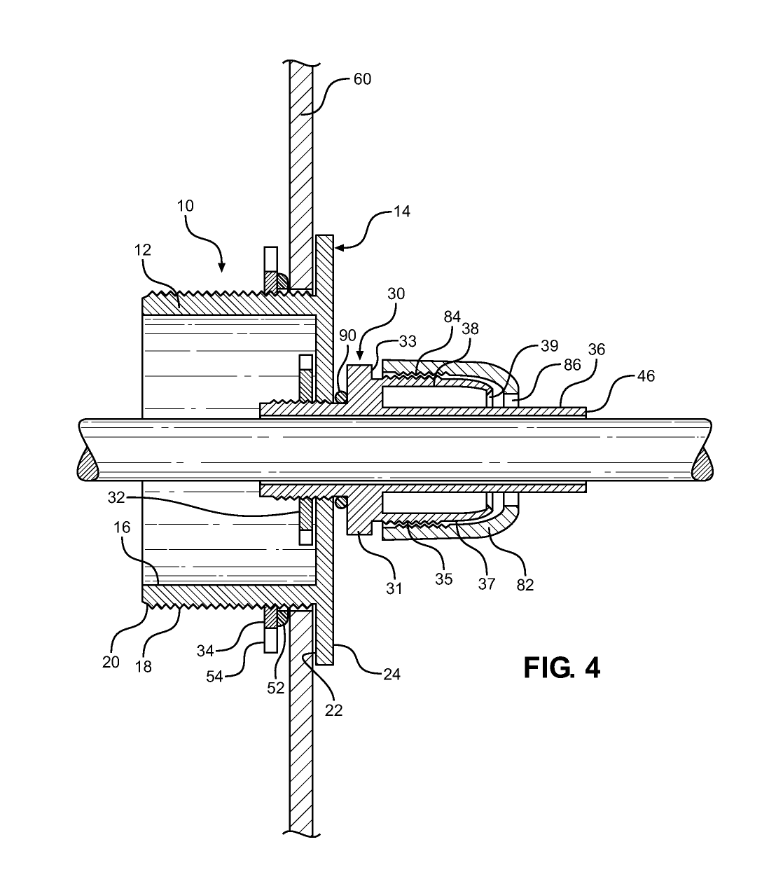

FIG. 5 is a cross-sectional view of the seal adapter of this invention with a cable threaded therethrough.

### DETAIL DESCRIPTION OF THE INVENTION

Turning now to the drawings in more detail, numeral 10 designates the seal adapter according to the present invention. The seal adapter 10 comprises a first hollow cylindrical portion 12 and second portion configured as an integrally connected cap 14. The cap 14 extends transversely to a central axis of the first cylindrical portion 12. An interior wall 16 of the cylindrical portion 12 is smooth, substantially protrusion free, while an exterior wall is provided with threads 18 extending from a free edge 20 of the cylindrical portion 12 to an intersection with an inner surface 22 of the cap 14.

The cap 14 has a polygonal shape, which can be a hexagonal shape, to allow engagement of the cap by conventional tightening tools. An exterior surface 24 of the cap 14 has a center indent 26; a mirror image center indent (not shown) is formed in the inner surface 22, the purpose of which will he discussed in more detail hereinafter. In the preferred embodiment, the cap 14 has greater peripheral dimensions than the exterior diameter of the cylindrical portion 12.

The kit assembly according to this invention contains the seal adapter 10, a conduit connector member 30, a first sealing ring 32 and a second sealing ring 34. The conduit connector member 30 comprises a hollow conduit body 36, a portion of which is surrounded by a first tightening member 38. A first proximate end 40 of the conduit body 36 carries exterior threads 42, while the opposite second distant end 46 of the conduit body 36 has a smooth exterior wall.

The conduit connector member 30 has a cross member 31 extending circumferentially outwardly in relation to the conduit body 36 a distance from the first end 40 and the second end 46 of conduit body 36, transversely to a longitudinal axis of the conduit body 36. The first tightening member 38 is unitary connected to the cross member 31. A shoulder 33 is defined between the first tightening member 38 and the cross member 31.

A portion of the first tightening member 38 is provided with exterior threads 35, while a plurality of flexible fingers 37 is formed on the body of the first tightening member 38. A central opening 39 is formed between the flexible fingers; the central opening 39 being sized and configured to allow a cable 80 to pass therethrough. The cable 80 can be an electric cable, a data transmission cable, a fiber optic cable, etc. The flexible fingers grip exterior of the cable 80 when they are forced closer together by a second tightening member 82.

The second tightening member 82 is detachably engageable with the first tightening member 38 by engagement of the exterior threads 35 of the first tightening member 38 with interior threads 84 of the second tightening member 82. As can be seen in the drawings, the second tightening member 82 is substantially cup-shaped and is configured to fit over the first tightening member 38 when positioned in a covering relationship over the first tightening member 38. Optional grooves 89 on the outside of the cup-shaped second tightening member 82 help manual gripping of the second tightening member 82 and rotation thereof.

An opening 86 is formed in a rounded portion 87 the second tightening member 82; the opening 86 is large enough to allow the second end 46 of the conduit body 36 to extend outwardly therefrom.

The first end 40 of the conduit body 36 has a diameter at least slightly smaller than an inner diameter of the first sealing ring 32, such that the first sealing ring 32 can be fitted over the first end 40 of the conduit body 36.

A plurality of outwardly equidistantly spaced-apart extending projections 50 is provided on the first sealing ring 32. The projections 50 extend outwardly from an exterior surface of the first sealing ring 32 to allow manual tightening of the first sealing ring when necessary. The first sealing ring 32 can be made of metal or plastic.

The second sealing ring 34 carries a flexible deformable O-ring 52, which can be made of urethane. The O-ring 52 is fitted in the interior surface of the second sealing ring 34. When positioned on the cylindrical portion 12 of the seal adapter 10, the O-ring 52 seals the interface between the cylindrical portion 12 and the second sealing ring 34. Similarly to the first sealing ring 32, the second sealing ring 34 is provided with a plurality of outwardly equidistantly spaced-apart extending projections 54 on its exterior surface to facilitate manual rotation of the second sealing ring 34 when positioning it on the cylindrical portion 12 of the seal adapter 10.

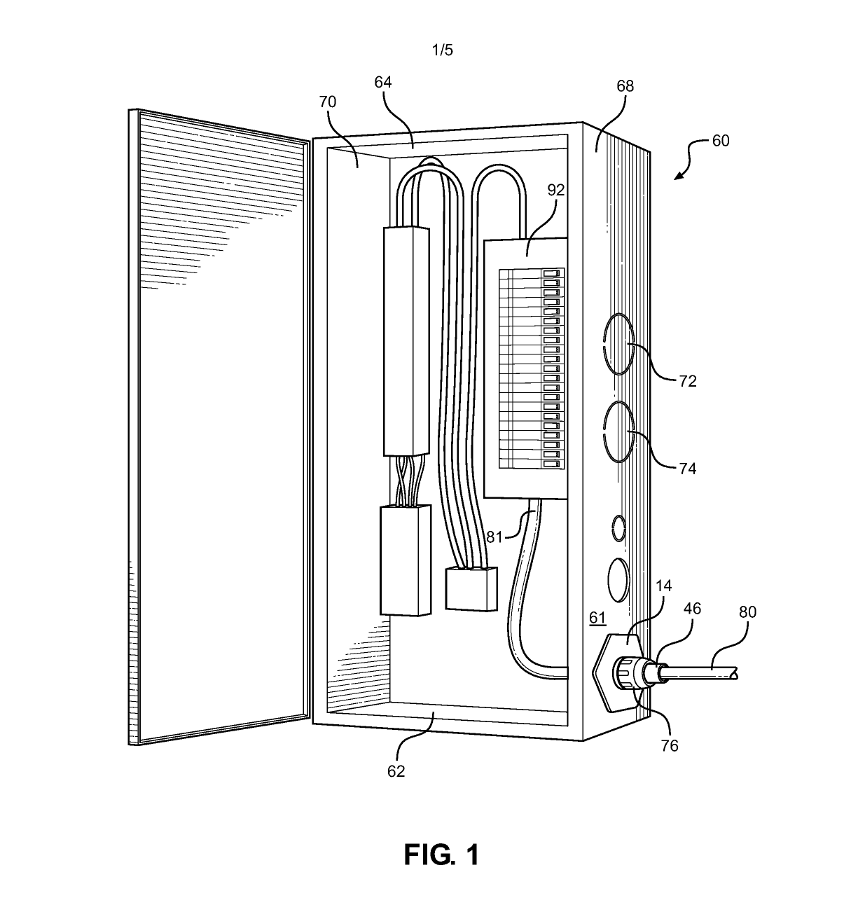

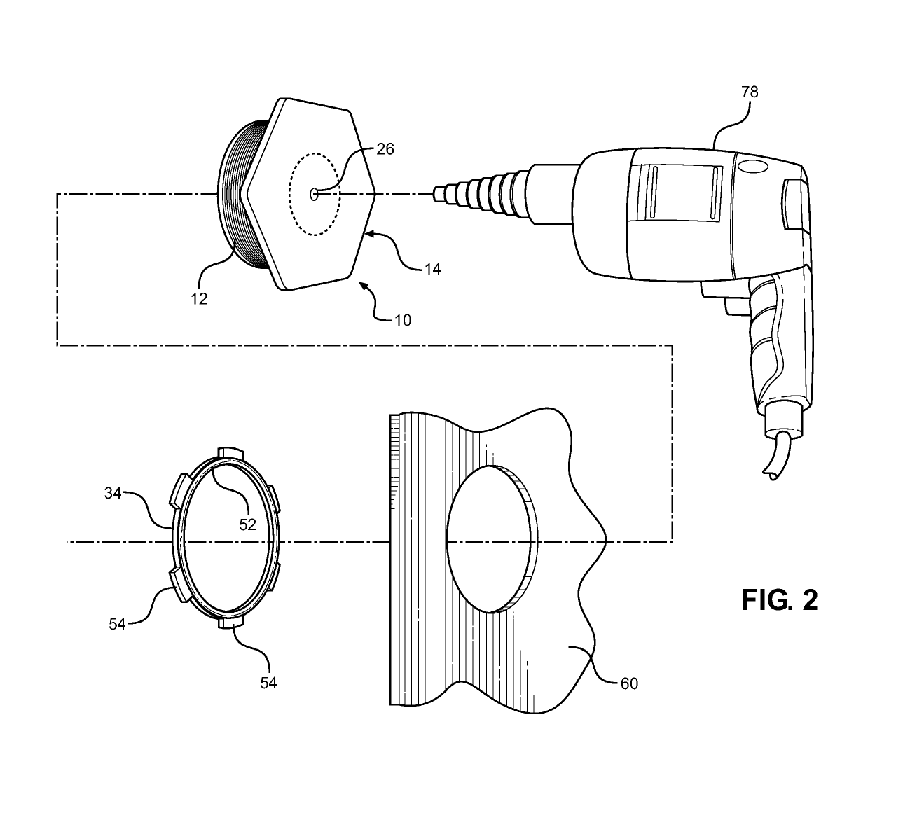

Turning now to FIGS. 1 and 2, preparation of the seal adapter 10 for installation in a distribution box 60 will be discussed in more detail. The distribution box 60 is conventionally made of sheet metal and/or plastic material. The box 60 has a parallelepiped configuration although other shapes can certainly be used. An exemplary distribution box 60 is shown in FIG. 1; it has a bottom wall 62, a top wall 64, and opposing sidewalls 68, 70. One or more entry ports 72, 74 are formed in one of the sidewalls, in this case, the sidewall 68. The entry port 76, where the seal adapter assembly of the present invention is mounted is partially obscured in the drawing.

The distribution box 60 forms an enclosure for the power and communications cables for a specific building (not shown). The distribution box may be mounted on an inside or outside wall of the building. It is highly desirable that the entry ports 72, 74, or 76 be sealed to prevent moisture from entering the enclosure. It will be appreciated that not all entry ports are used in every case; some of the pre-drilled entry ports will remain unused. Conventionally, the unused entry ports are closed by a detachable plug or plate that fits in the entry port and closes the opening.

As discussed above, in many cases, the sealing plugs and plates are formed from metal. To thread an electric or communications cable into the distribution box, the user drills an opening in the sealing plug or plate according to the specific dimensions of the cable. The small particles created during a metal drilling process tend to remain on the surface of the distribution box and can potentially interfere with the electrical current or communication stream. The seal adapter of the present invention solves this problem in a simple and efficient manner.

Using the indentation 26 as a drilling guide, the user drills out the cap 14, as schematically shown in FIG. 2, forming an opening 11 according to the pre-determined dimensions. A conventional hand tool, such as an electric drill 78 can be used when forming the opening 11. The seal adapter 10 is then positioned in the entry port (in this case entry port 76) such that the inner surface 22 of the cap 14 contacts an exterior surface 61 of the sidewall 68. The cylindrical portion 12, being smaller than the entry port 76 extends into the interior of the distribution box 60.

The user then positions the conduit connector member 30 within the opening 11 in the cap 14 such that the first end 40 of the conduit connector member 30 is threadably engaged or tightly fits in the through opening 11. An optional O-ring 90 is fitted between an exterior surface 24 of the cap 24 and the cross member 31, thereby sealing the opening 11 from the outside of the distribution box 60. The second tightening member 82 can no be positioned over the first tightening member 38 without threadably engaging the two tightening members.

The first sealing ring 32 is then positioned on the first end 40 of the conduit body 36 on the inside of the distribution box 60 by threadably engaging the threads 42 with the inner threads on the first sealing ring 32. The second sealing ring 34 is fitted on the cylindrical portion 12 of the adapter 10 by engaging matching threads 18 with the inner threads of the second sealing ring. The O-ring seal 52 is fitted between the inner wall of the distribution box 60 and the second sealing ring 34. The O-rings 90 and 52 form a weatherproof seal for the seal adapter 10. The projections 50 and 54 facilitate engagement of the sealing rings 32, 34 by hand or by pliers and the like.

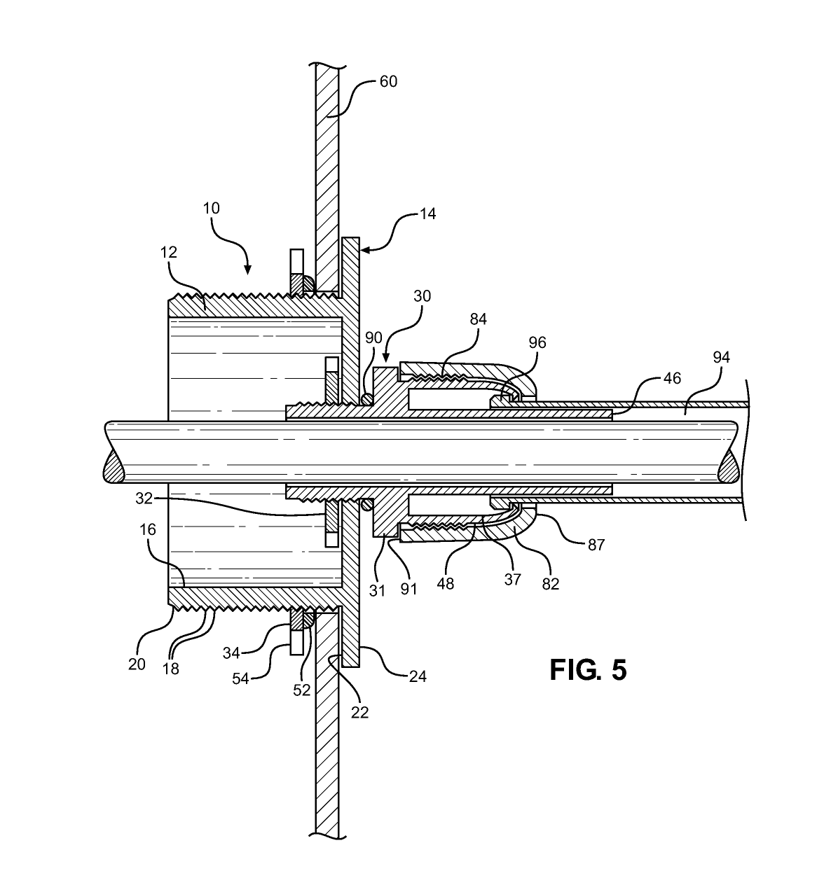

An electric, data, or a fiber optic cable 80 can now be guided through the conduit connector member 30 into the interior of the distribution box 60. The guiding end 81 of the cable 80 can be engaged with a distribution panel 92 in a well-known manner. The conduit connector supports the cable 80, while the seal adapter 10 seals the entry port 76 of the distribution box 60. The second tightening member 82 can now be threadably engaged with the first tightening member 38 such that the proximate edge 91 of the second tightening member 82 contacts the shoulder 33 on the cross member 31. The flexible fingers 37 are compressed closer together and grip exterior of the cable 80. This position of the second tightening member 82 is shown in FIG. 5.

FIG. 5 also illustrates an embodiment, where the cable 80 is provided with insulation 94. In some embodiments, it may be necessary to strip the insulation from the guiding end of the insulation cable before it enters the conduit connector member 30. In that case, the cut end 96 of the insulation may be forced into the opening 39 between the flexible fingers 37 and the exterior of the cable 80.

Many changes and modifications can be made in the present invention without departing from the spirit thereof. I therefore pray that my rights to the present invention be limited only by the scope of the appended claims.

I claim:

1. A seal adapter device for guiding an electric or data cable through an entry port into a distribution box, the seal adapter comprising a seal adapter body capable of being threaded into an existing entry port of the distribution box, the seal adapter body comprising a first portion carrying exterior threads and an enlarged-size cap integrally continuously formed with the first portion, the second portion extending transversely to a central axis of the first portion.

2. The device of claim 1, wherein said cap is capable of being drilled when forming an opening in the cap through which the cable extends.

3. The device of claim 2, wherein an indentation is formed in a center part of the cap, said indentation defining a guide for chilling of the cap.

4. The device of claim 1, wherein the first portion has a hollow cylindrical configuration.

5. The device of claim 1, wherein said cap has a polygonal configuration.

6. A seal adapter assembly for guiding an electric or data cable through an entry port into a distribution box, the seal adapter assembly comprising a seal adapter device capable of being positioned in the entry port of the distribution box, a conduit connector member engageable with the seal adapter device, a first sealing ring engageable with the conduit connector member and a second sealing ring engageable with the seal adapter device.

7. The assembly of claim 6, said seal adapter device comprising a seal adapter body capable of being threaded into the existing entry port of the distribution box, the seal adapter body comprising a first portion carrying exterior threads and an enlarged-size cap integrally continuously formed with the first portion, the second portion extending transversely to a central axis of the first portion.

8. The assembly of claim 7, wherein the second sealing ring is engageable with exterior threads of the first portion.

9. The assembly of claim 7, wherein said cap is capable of being drilled when forming an opening in the cap through which the cable extends.

10. The assembly of claim 9, wherein an indentation is formed in a center part of the cap, said indentation defining a guide for drilling of the cap.

11. The assembly of claim 7, wherein the first portion has a hollow cylindrical configuration.

12. The assembly of claim 7, wherein said cap has a polygonal configuration.

13. The assembly of claim 6, wherein the second sealing ring carries a second sealing O-ring positionable between an interior wall of the distribution box and the second sealing ring.

14. The assembly of claim 6, wherein the first sealing ring is provided with a plurality of outwardly extending spaced-apart projections.

15. The assembly of claim 6, wherein the second sealing ring is provided with a plurality of outwardly extending spaced-apart projections.

16. The assembly of claim 6, wherein the conduit connector member comprises an elongated conduit having a first proximate end provided with exterior threads engageable with the first sealing ring and a second distant end having a smooth exterior.

17. The assembly of claim 16, said conduit connector body further comprises a first tightening member extending in a surrounding relationship over at least a portion of the distant end of the elongated conduit, said first tightening member carrying a plurality of flexible fingers.

18. The assembly of claim 17, comprising a second tightening member capable of detachable engagement with the first tightening member and imparting compression force on the flexible fingers such that the flexible fingers grip the cable extending through the conduit connector member.

19. The assembly of claim 18, wherein a cross member extends outwardly from the elongated conduit between the first proximate portion and the second distant portion.

20. The assembly of claim 19, wherein said second tightening member abuts the cross member when tightened around the first tightening member.

21. The assembly of claim 19, comprising a first sealing O-ring positionable between the cross member and the cap of the seal adapter device.
